(19) United States
(12) Patent Application Publication
(10) Pub. No.: US 2009/0226071 A1
(43) Pub. Date: Sep. 10, 2009

(54) Method and Apparatus to Facilitate Using Visible Light Images to Determine a Heart Rate

(75) Inventors: Francesca Schuler, Des Plaines, IL (US); Mohamed I. Ahmed, Glendale Heights, IL (US); Thomas D. Biancullli, Manorville, NY (US); Mark W. Cholewczynski, Wheaton, IL (US); Krishna Jonnalagadda, Algonquin, IL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/043,515

(22) Filed: Mar. 6, 2008

(51) Int. Cl. G06K 9/00

(52) U.S. Cl. 382/133

(57) ABSTRACT

An apparatus (400) can receive (101) a plurality of visible light images as correspond to a subject's skin (403) proximal to a blood-transporting capillary (404) and then process (102) that plurality of visible light images to thereby determine a heart rate for the subject. These teachings will accommodate both light-transmissive images and light-reflective images. By one approach, these visible light images can comprise images that are captured by use of a cellular telephone camera (402). The aforementioned processing can occur, in whole or in part, at the cellular telephone or at a remotely located server (408).

### TECHNICAL FIELD

This invention relates generally to photoplethysmography and more particularly to the use of light to determine a heart rate.

### BACKGROUND

The use of light to determine a heart rate for a given subject is known in the art. As the heart pumps blood a corresponding pulse distends blood-transporting capillaries (such as arteries and arterioles) in the subcutaneous tissue of the subject. A corresponding change in volume can be detected by illuminating the skin with, for example, a light emitting diode and then measuring the amount of light that is transmitted or reflected by use of a photodiode. Each cardiac cycle evidences itself as a peak during such measurements.

Devices capable of operating in this manner are available. Their availability is important as determining one's heart rate can comprise an important activity to many persons for any number of reasons. For example, accurately determining a heart rate can comprise an important part of one's health regimen. Determining a heart rate can also comprise an important diagnostic input in many application settings.

That said, present solutions do not always meet all end user requirements in all application settings. At the very least, such devices constitute at least yet one more device that an interested end user must maintain, keep powered, and carry about as needed. This can lead to unwanted surprises regarding the unpowered status of the device during a time of need and/or the present unavailability of the device during a time of need because the end user has not included the device amongst the items that the end user carries about.

### BRIEF DESCRIPTION OF THE DRAWINGS

The above needs are at least partially met through provision of the method and apparatus to facilitate using visible light images to determine a heart rate described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a block diagram as configured in accordance with various embodiments of the invention;

FIG. 5 comprises an illustrative example of a visible light image;

FIG. 6 comprises an illustrative example of a resultant binary image;

FIG. 7 comprises a reduced dimensionality graphic representation as corresponds to the resultant binary image;

FIG. 8 comprises a filtered reduced dimensionality graphic representation as corresponds to the resultant binary image; and

FIG. 9 comprises a graphic representation of extracted heart beat data.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an apparatus can receive a plurality of visible light images as correspond to a subject's skin proximal to a blood-transporting capillary and then process that plurality of visible light images to thereby determine a heart rate for the subject. These teachings will accommodate both light-transmissive images and light-reflective images. By one approach, these visible light images can comprise images that are captured by use of a cellular telephone camera. The aforementioned processing can occur, in whole or in part, at the cellular telephone itself or at a remote location/facility (such as at a corresponding server).

By one approach, the visible light images can comprise images having corresponding color components. In such a case, the aforementioned processing can comprise transforming the corresponding color components into different color components. For example, this can comprise providing RGB-based images and transforming those images into images comprised of hue saturation value (HSV) components. This and other processing steps can provide corresponding high contrast images. The dimensional content of these high contrast images can then be reduced to provide corresponding reduced-dimensionality images. The latter can comprise, for example, selecting and using only one image component from amongst a plurality of image components that comprise the corresponding high contrast images.

The present teachings are well suited to permit an ordinary visible light digital camera (such as often comprises a part of a modern cellular telephone, personal digital assistant, or the like) to provide data that is readily processed and converted into an accurate determination of the heart beat for a given individual. It will be appreciated that these results are readily achieved in many cases with only a relatively few consecutive images. For example, as few as 100 to 200 such images (captured, for example, at 10 to 15 frames per second over, say, 10 seconds) can be sufficient to provide a relatively accurate determination of one's heart beat.

The corresponding processing and power consumption requirements to support these approaches are sufficiently modest and hence permit a cellular telephone, personal digital assistant, or other portable device to successfully serve as the enabling platform for these teachings. That, in turn, permits any number of ordinarily available devices which are already carried and regularly used by end users to support these capabilities in a native fashion. As a result, the benefits of being able to quickly and accurately determine one's heart rate can now be available without requiring the end user to possess, maintain, and carry about a dedicated device for this purpose.

These and other benefits may become clearer upon making a thorough review and study of the following detailed description. Referring now to the drawings, and in particular to FIG. 1, an illustrative process 100 that is compatible with many of these teachings will now be presented. This process 100 can be carried out, in whole or in part, by a corresponding apparatus. By one approach, this apparatus can comprise a portable, personal device such as a cellular telephone, a personal digital assistant, or the like. In such a case, the apparatus itself will likely be used in close conjunction with the person whose heart rate is to be determined. By another approach, this apparatus can be located remotely from this person. This can comprise, for example, a server that is physically remote from the person by many miles.

This process 100 provides for the apparatus receiving 101 a plurality of visible light images as correspond to a subject's skin proximal to a blood-transporting capillary. As used herein, this reference to “visible light images” will be understood to refer to photographs (including, perhaps most typically, digital photographs) of the kind that are normally associated with an ordinary visible light image capture component such as a camera. This can include, as noted below, normal color images as well as essentially any other visible light photographic format including, but not limited to, the RGB format, the HSV format, a grayscale format, and so forth. Generally speaking, these visible light images will have a size/resolution of at least 100×100 pixels with 176×144-sized images serving very well in this regard and with higher resolution and/or sized pictures being more than adequate as well.

This process 100 will accommodate receiving 101 either light-transmissive images (where visible light passes through the skin/capillary to reach the image capture component) or light-reflective images (where the visible light that reaches the image capture component comprises light that has been reflected from the skin's surface).

The number of visible light images that are so received can vary to some extent with the application setting. In general, for most purposes, it may be appropriate to receive at least 100 to 200 such images, where the images comprise images that have been captured at substantially regular intervals of about 10 to 15 frames per second. Generally speaking, the greater the frame rate the greater the corresponding accuracy of the heart beat determination.

This process 100 then provides for processing 102 the plurality of visible light images to thereby determine a heart rate for the subject. This can comprise, by one approach, dynamically assessing image quality on a frame-by-frame basis to determine the suitability of each image for use in determining the heart rate for the subject. There are various reasons why a given visible light image may not be useful for these purposes and such a step will permit identifying such images in order to avoid, for example, expending further processing resources with such unsuitable images.

By one approach, the received visible light images can each be provided with a time stamp that corresponds to a point in time when the image was captured. In such a case, this step of processing 102 the visible light images can comprise, in part, monitoring these time stamps as correspond to the plurality of visible light images and using those time stamps when processing the images to determine the heart rate for the subject. By another approach, the intervals between the images can comprise a pre-known amount of time.

There are various ways by which such processing 102 can be achieved. Prior to discussing some alternatives in that regard, however, it may be useful to again note that the apparatus may be remotely located with respect to the subject. In such a case, this process 100 will further optionally accommodate transmitting 103 the determined heart rate information to the subject. When the visible light images are being captured in the first instance by the subject's cellular telephone, for example, this step can comprise forwarding the corresponding heart rate information to that subject via that cellular telephone. As represented by the phantom line denoted by reference numeral 104, this process 100 can also accommodate then continuing to receive additional visible light images and continuing to determine a subsequent or on-going heart rate for the subject. These subsequent results can then be transmitted to the subject and the process similarly continued until concluded as desired.

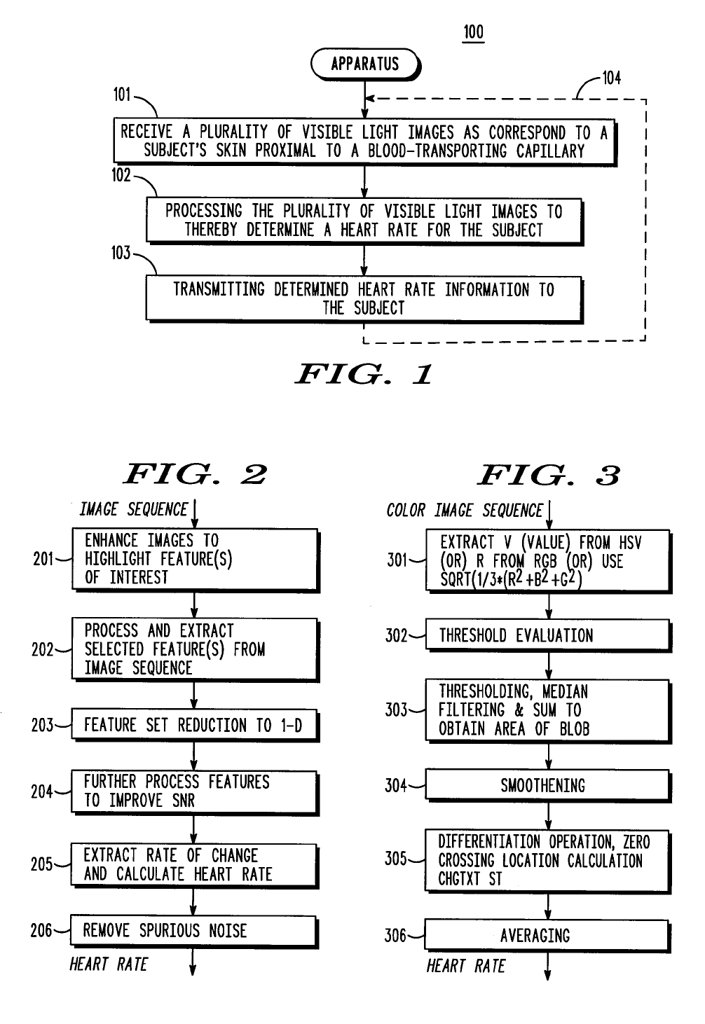

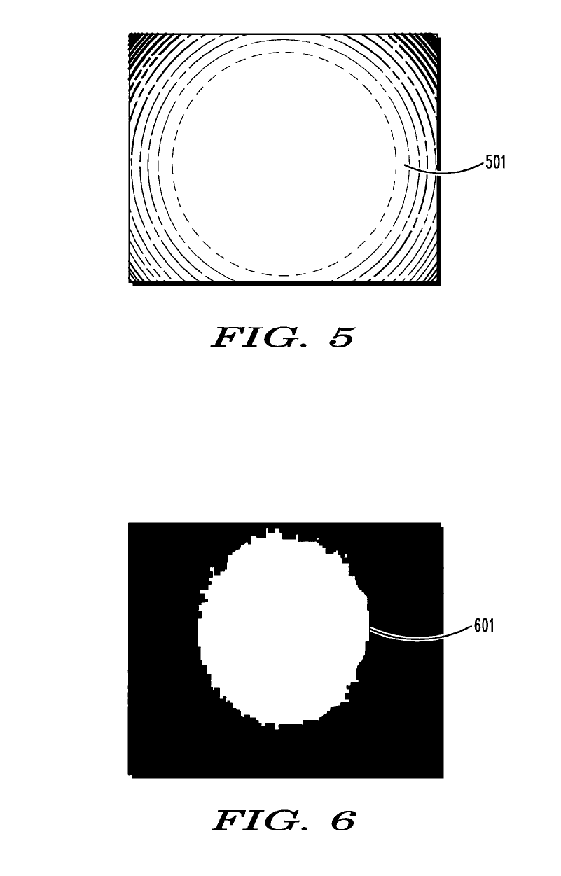

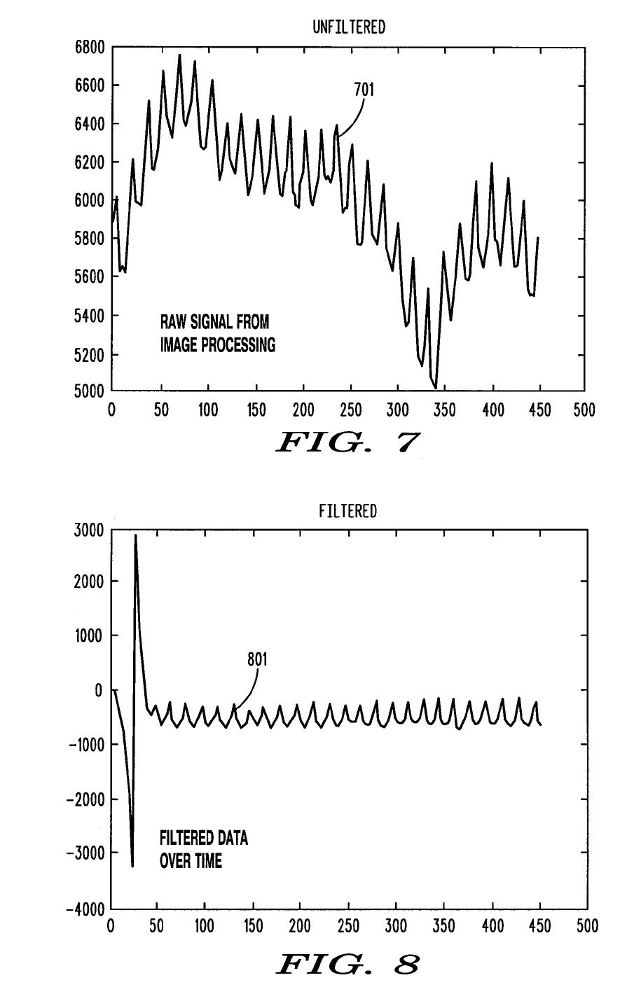

As suggested by the illustration provided at FIG. 5, a given visible light image 501 will typically comprise a relatively indistinct offering. Variations in such an image that are useful to mark the presence of a heart beat will tend to be relatively slight. Referring now to FIG. 2, the aforementioned step of processing such a visible light image can comprise, by one approach, first enhancing 201 those images to highlight one or more particular features of interest. Useful enhancement techniques in this regard include two-dimensional filtering, contrast enhancement, edge enhancement, median filtering, and so forth. Applying such techniques to an image such as the one provided in FIG. 5 can result, by way of illustration, in a highly contrastive and reduced dimensionality image such as the result 601 shown at FIG. 6. As will be discussed in more detail below, such enhancement can considerably aid in permitting this use of ordinary visible light photographs to detect heart beat indicia.

These enhanced images are then processed 202 in facilitate extracting one or more selected features from the image sequence. This can comprise, for example, the use of threshold determination, Hough transformations, edge detection and location, median filtering, and so forth. The extraction activity can comprise, for example, the use of thresholding and summing to calculate an area of a given image that is above a given threshold, area calculations after a Hough transform, absolute location of an edge given an axis of interest, two-dimensional Fast Fourier Transform (FFT) analysis and corresponding peak frequency extraction, and so forth.

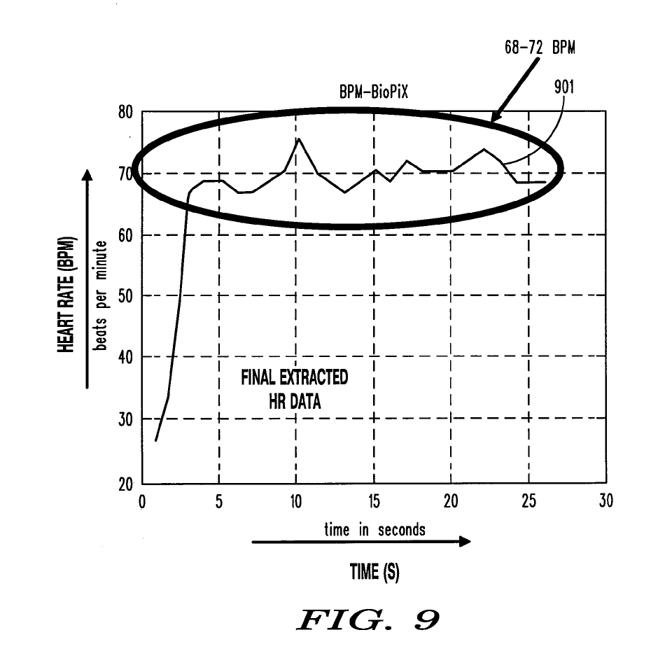

The extracted feature set is then reduced 203 to a one-dimensional representation. An illustrative example 701 in this regard appears at FIG. 7. This can be achieved using, for example, vector quantization, principal component analysis, area calculations, and so forth. By one approach, this processing can also include further processing 204 of these features to improve the corresponding signal-to-noise ratio (SNR). This can comprise, for example, the use of further filtering, smoothening, averaging, and so forth as desired. An illustrative example 801 in this regard appears at FIG. 8.

The subject's heart rate 901 (as shown in FIG. 9) can then be calculated by extracting 205 the rate of change from this (possibly noise reduced) reduced dimensionality feature set of information. This can be achieved using any of a variety of approaches including harmonic analysis, peak detection, differentiation, periodicity of peaks (or troughs), zero crossing detection, and so forth. If desired, this can be followed by the removal 206 of spurious noise by the use, for example, of averaging techniques.

The above described approach comprises a fairly general overview of a facilitating process by which the plurality of visible light images can be processed to determine the heart rate for a given subject. Referring now to FIG. 3, a more specific example in this regard will now be provided.

In this illustrative example the received visible light images comprise a sequence of color images having corresponding color components. These color images are then processed to transform the corresponding color components into different color components. For example, the original visible light images may comprise Red Green Blue (RGB) color components which are then transformed into another set of color components that can be better suited to extracting image content that evidences a heart beat. Examples of such alternative color components include Hue Saturation Values (HSV), YCb, Cr, CMYK, and so forth which are all well known in the art.

If desired, the visible light images can be further processed with respect to other non-standard dimensions. For example, the RGB values for a given image could be combined with the V value of the corresponding HSV information to provide new “color” dimensions. These results are likely to be aesthetically unsatisfying and unusual but may be valid to better facilitate extracting the desired heart rate information by highlighting particular emergent features that serve well in this specific regard.

This transformed multidimensional image can then be reduced to fewer dimensions. This can comprise, for example, providing corresponding images of Hue Saturation Value (HSV) components and then processing those images of HSV components to provide corresponding high contrast images. The dimensional content of these high contrast images can be reduced to yield corresponding reduced-dimensionality images. This might comprise, for example, extracting only the V (value) component of the HSV-based images and then using only that one extracted image component for these purposes.

As another example, this might comprise extracting, say, the R (red) component when the images comprise RGB-based images. As another approach when the high contrast images comprise Red Green Blue (RGB) color model images, this can comprise processing the Red Green and Blue component values as a function of \sqrt{(R²+G²+B²)}.

The resultant one-dimensional content of the corresponding results can then be converted to a plurality of corresponding binary images. This can comprise, for example, processing the plurality of visible light images with respect to a threshold, such that pixel values that exceed the threshold are converted to a first color value and pixel values that are below the threshold are converted to a second color that is highly contrastive with respect to the first color. By one approach, for example, the first color can be black and the second color can be white. The result of such an approach is shown by way of example in FIG. 6.

However achieved, the aforementioned reduced-dimensionality binary images can then be filtered to provide corresponding filtered images. By one approach this can comprise employing frequency domain processing techniques (such as, but not limited to, Fourier analysis techniques) to identity individual heart beats. By another approach, in combination with the above or in lieu thereof, this can comprise employing time domain processing techniques (such as, but not limited to, peak detection, zero crossing detection, and so forth) to identify the heart beats.

These activities are generally represented in FIG. 3 as follows. Selected information is extracted 301 from the incoming images and the resultant image components then evaluated 302 using one or more thresholds. The resultant highly contrastive and reduced dimensionality images are then processed 303 to identify what pictorially can be characterized as “blobs” of interest (with an illustrative example of such a blob being shown in FIG. 6). After smoothening 304, images reflecting a heart beat are identified 305 followed by averaging 306 to remove spurious noise.

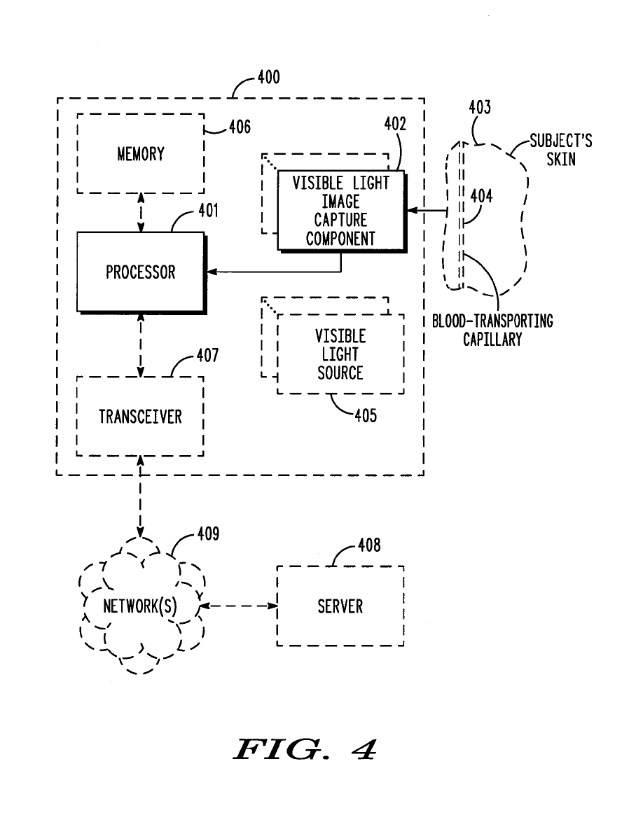

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform will now be provided.

As noted above, this apparatus 400 can comprise a remotely located platform such as a server that is accessed via the Internet or can comprise a personally portable apparatus such as a personal digital assistant or a portable wireless two-way communications apparatus such as a cellular telephone, a press-to-talk walkie talkie, or the like. In this illustrative example, the apparatus 400 comprises a processor 401 that operably couples to a visible light image capture component 402 (or components when more than one such component is provided). This visible light image capture component 402 may comprise, for example, a camera such as a general purpose camera as is provided with many modern cellular telephones.

This visible light image capture component 402 is suitable to permit capturing visible light images of a subject's skin 403 that is proximal to a blood-transporting capillary 404. The latter proximity should be such that the increased pressure associated with a heart beat is visually evident via the subject's skin 403. By one approach, these captured images can be based upon an external transmissive visible light source (not shown) such that the visible light passes through the subject's tissue. By another approach, these captured images can be based upon reflective visible light that reflects off the subject's skin 403.

In the latter instance, if desired, the reflective visible light can be initially source, at least in part, from one or more visible light sources 405 as comprise a part of the apparatus 400. This visible light source 405 can comprise, for example, a light emitting diode that serves as a flash for the visible light image capture component 402 during ordinary use of the latter. By another approach, this flash element can be dedicated to use only when capturing images in order to determine the subject's heart beat. Other sources of visible light may serve in these regards as well. For example, if desired, the visible light source 405 can comprise a display backlight as may otherwise comprise a part of the apparatus 400.

Those skilled in the art will recognize and appreciate that such a processor 401 can comprise a fixed-purpose hard-wired platform or can comprise a partially or wholly programmable platform (such as a microprocessor or microcontroller). All of these architectural options are well known and understood in the art and require no further description here. This processor 401 can be configured and arranged (via, for example, appropriate programming as will be well understood by those skilled in the art) to carry out one or more of the steps, actions, and functionality as has been set forth herein. This can include, for example, receiving the aforementioned visible light images from the visible light image capture component 402 and processing those images to thereby determine a heart rate for the subject.

If desired, this apparatus 400 can further comprise a memory 406 that operably couples to the processor 401. This memory 406 can serve to store, temporarily or permanently, the visible light images, the interim image processing results, and/or the determined heart beat information. This memory 406 can also serve to store the operating instructions that permit the processor 401 to carry out the described steps.

As noted, the apparatus 400 can have two-way wireless communications capability if desired. To facilitate such a capability, the apparatus 400 and further optionally comprise a transceiver 407 (such as a cellular telephone transceiver) that permits, for example, the apparatus 400 to communicate with a server 408 via one or more intervening networks 409 (such as a cellular telephone network, the Internet, and so forth). In such a case, if desired, the apparatus 400 can serve to collect the aforementioned visible light images and then forward that information (either in its original form or as partially processed in accordance with these teachings) to the server 408 where processing of the information concludes. The server 408 can then return the extracted heart rate information to the apparatus 400 where it can be provided to the subject or other end user using a presentation modality of choice.

Those skilled in the art will recognize and understand that such an apparatus 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, commonly available capabilities (such as cellular telephones that are equipped with relatively modest image capture capabilities) are readily leveraged to provide efficient and accurate heart beat determination. These teachings permit the extraction of such information from only a relatively few images. This, in turn, minimizes image capture requirements and processing requirements. This also permits such a capability to be an integral native aspect of commonly available and commonly carried apparatuses such as cellular telephones. This avoids the need for an interested end user to separately acquire, maintain, and carry a discrete device to serve this particular facility.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an apparatus:
receiving a plurality of visible light images as correspond to a subject's skin proximal to a blood-transporting capillary;
processing the plurality of visible light images to thereby determine a heart rate for the subject.

2. The method of claim 1 wherein the plurality of visible light images comprise at least one of:
light-transmissive images;
light-reflective images.

3. The method of claim 1 wherein the plurality of visible light images comprise images having corresponding color components and wherein processing the plurality of visible light images comprises, at least in part:
processing the plurality of visible light images to transform the corresponding color components into different color components.

4. The method of claim 3 wherein processing the plurality of visible light images to transform the corresponding color components into different color components comprises providing corresponding images of hue saturation value (HSV) components;
and wherein processing the plurality of images further comprises processing the corresponding images of hue saturation value (HSV) components to provide corresponding high contrast images.

5. The method of claim 3 wherein processing the plurality of visible light images further comprises, at least in part:
reducing dimensional content of the corresponding high contrast images to provide corresponding reduced-dimensionality images.

6. The method of claim 5 wherein reducing dimensional content of the corresponding high contrast images comprises at least one of:
reducing dimensional content of the corresponding high contrast images by selecting and using only one image component from amongst a plurality of image components as comprise the corresponding high contrast images;
when the corresponding high contrast images comprise red green blue (RGB) color model images, processing red green and blue component values as a function of \sqrt{(R²+G²+B²)};
reducing dimensional content of the corresponding reduced-dimensionality images by converting the plurality of visible light images to a plurality of corresponding binary images.

7. The method of claim 6 wherein selecting and using only one image component comprises selecting and using only value components of hue saturation value (HSV) image components as comprise the plurality of image components.

8. The method of claim 6 wherein converting the plurality of visible light images to a plurality of corresponding binary images comprises processing the plurality of visible light images with respect to a threshold, such that pixel values that exceed the threshold are converted to a first color value and pixel values that are below the threshold are converted to a second color that is highly contrastive with respect to the first color.

9. The method of claim 5 wherein processing the plurality of visible light images comprises, at least in part:
filtering the corresponding reduced-dimensionality images to provide filtered images;
processing the filtered images using at least one of:
frequency domain processing techniques;
time domain processing techniques;
to identify heart beats.

10. The method of claim 9 wherein:
processing the filtered images using frequency domain processing techniques comprises, at least in part, using fast Fourier transforms processing techniques to identify the heart beats; and
processing the filtered images using time domain processing techniques comprises, at least in part, using at least one of:
peak detection processing techniques; and
zero crossing detection processing techniques;
to identify the heart beats.

11. The method of claim 1 wherein the apparatus is located remotely from the subject's skin.

12. The method of claim 11 wherein processing the plurality of visible light images to thereby determine a heart rate for the subject comprises, at least in part:
monitoring time stamps as correspond to the plurality of images;
using the time stamps when processing the plurality of images to determine the heart rate for the subject.

13. The method of claim 11 further comprising:
transmitting determined heart rate information to the subject while continuing to received additional images and continuing to determine a subsequent heart rate for the subject.

14. The method of claim 1 wherein processing the plurality of visible light images to thereby determine a heart rate for the subject comprises, at least in part:
dynamically assessing image quality on a frame-by-frame basis to determine suitability of the images for use in determining the heart rate for the subject.

15. An apparatus comprising:
a visible light image capture component;
a processor operably coupled to the visible light image capture component and being configured and arranged to:
receive, from the visible light image capture component, a plurality of visible light images as correspond to a subject's skin proximal to a blood-transporting capillary;
process the plurality of visible light images to thereby determine a heart rate for the subject.

16. The apparatus of claim 15 wherein the apparatus comprises a portable wireless two-way communications apparatus.

17. The apparatus of claim 15 wherein the visible light image capture component comprises a camera.

18. The apparatus of claim 17 wherein the apparatus further comprises a visible light source that is controlled to provide visible light to facilitate capturing visible light images via the visible light image capture component.

19. The apparatus of claim 18 wherein the visible light source comprises a display backlight.

20. The apparatus of claim 17 wherein the camera comprises a general purpose camera.
